(19) United States
(12) Patent Application Publication
(10) Pub. No.: US 2017/0228359 A1
(43) Pub. Date: Aug. 10, 2017

(54) Browser Based Snap Grid

(71) Applicant: Prysm, Inc., San Jose, CA (US)

(72) Inventor: Adam P. Cuzzort, Westfield, IN (US)

(73) Assignee: Prysm, Inc., San Jose, CA (US)

(21) Appl. No.: 15/403,148

(22) Filed: Jan. 10, 2017

Related U.S. Application Data
(60) Provisional application No. 62/292,709, filed on Feb. 8, 2016.

(51) Int. Cl. G06F 17/24; G06F 3/0485; G06F 3/0484; H04L 29/06; G06F 3/14

(52) U.S. Cl. CPC G06F 17/246; H04L 65/403; G06F 3/1454; G06F 3/04847; G06F 3/0485

(57) ABSTRACT

Various embodiments provide a so-called snap grid that can be shared amongst various appliances in a collaborative workspace environment. A snap grid is a logical object that defines a series of cells. The cells can be generally contiguous with one another, or can be detached from one another and spread out across a workspace. In operation, a snap grid is assigned to a given workspace and serves to enable assets, such as digital content, to be fixed in predefined locations within the workspace. Snap grids are defined and rendered based on percentages of the total workspace that the snap grid occupies. These percentages can be described by metadata to permit snap grids to be shared and rendered across other appliances in the collaborative environment.

### RELATED APPLICATIONS

This application is related to and priority is claimed from U.S. Provisional Application No. 62/292,709, filed on Feb. 8, 2016, the disclosure of which is incorporated by reference in its entirety.

### BACKGROUND

Currently, digital content may be shared between different computer devices implementing various techniques. During a content sharing session, a shared workspace that includes various types of digital content may be displayed on multiple computer devices at different physical locations, or a shared workspace displayed on one computer device may be shared with different remote computer devices. Challenges continue for those who develop collaboration systems to make the sharing experience more efficient and to improve the user experience.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of a collaboration system operable to employ techniques described herein.

FIG. 2 is a conceptual diagram of a communication infrastructure of the collaboration system of FIG. 1 as sharing content streams across appliances.

FIG. 3 depicts a streaming infrastructure of FIG. 2 in greater detail.

FIG. 4 depicts a messaging infrastructure of FIG. 2 in greater detail.

FIG. 5 depicts a large-format appliance that includes a snap grid in accordance with one or more embodiments.

FIG. 6 depicts a procedure in an example implementation in which snap grids can be employed in a shared workspace.

FIG. 7 depicts a large-format appliance and a reduced-format appliance in accordance with one or more embodiments.

FIG. 8 depicts a large-format appliance and a reduced-format appliance in accordance with one or more embodiments.

FIG. 9 depicts a procedure in an example implementation in which snap grids can be employed in a shared workspace.

FIG. 10 illustrates an example system including various components of an example device that can be implemented as any type of computing device as described to implement embodiments of the techniques described herein.

### DETAILED DESCRIPTION

### Overview

Various embodiments provide a so-called snap grid that can be shared amongst various appliances in a collaborative workspace environment. A snap grid is a logical object that defines a series of cells. The cells can have any shape, but are typically four-sided in nature, such as rectangular. The cells can be generally contiguous with one another, or can be detached from one another and spread out across a workspace.

In operation, a snap grid is assigned to a given workspace and serves to enable assets, such as digital content, to be fixed in predefined locations within the workspace. In some instances, an asset can be placed into a grid cell and can be automatically re-sized to fit the cell. A snap grid can have any number of cells that can be positioned anywhere within a particular workspace. Snap grids are defined and rendered based on percentages of the total workspace that the snap grid occupies. These percentages can be described by metadata to permit snap grids to be shared and rendered across other appliances in the collaborative environment.

In this manner, metadata describing these percentages can be shared with other appliances, such as reduced-format appliances, and based on this metadata, corresponding snap grids can be rendered in corresponding locations on the workspace of the other appliances. In some instances, snap grids can be rendered by a client application in the form of a web browser. If a web browser is moved or resized, associated web browser events cause the snap grids to be automatically recalculated using the same percentage-based formula that was used to originally render the snap grid on the web browser. This recalculation can be performed anytime a user moves or resizes the web browser.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

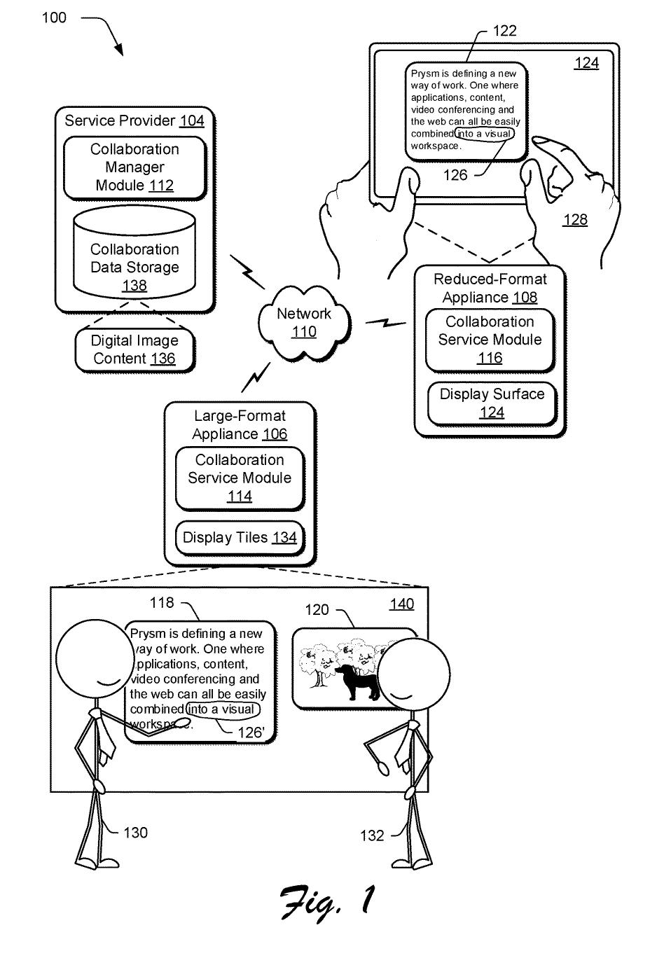

FIG. 1 is an illustration of a collaboration system 100 in an example implementation that is configured to implement one or more aspects of the techniques described herein. As shown, collaboration system 100 includes, without limitation, a service provider 104 and appliances that are used to implement a shared workspace, illustrated examples of which include a large-format appliance 106 and a reduced-format appliance 108, each of which are communicatively coupled via a network 110. The large-format appliance 106 is one that has a physically self-supporting display (e.g., greater than 35 inches diagonal) with rich hardware resources including processing, memory, or network resources, which may support simultaneous interaction with a plurality of users as illustrated. The reduced-format appliance 108, on the other hand, has a housing configured to be held by one or more hands of a user or placed on a surface (e.g., as a display device of a personal computer) and may have reduced processing, memory, and network resources in comparison to the large-format appliance 106, which support single user interaction due to this size. Although large and reduced format appliances 106, 108 are described in relation to the following examples, it should be readily apparent that a plurality of appliances may be made up of appliances that support large or reduced formats, solely.

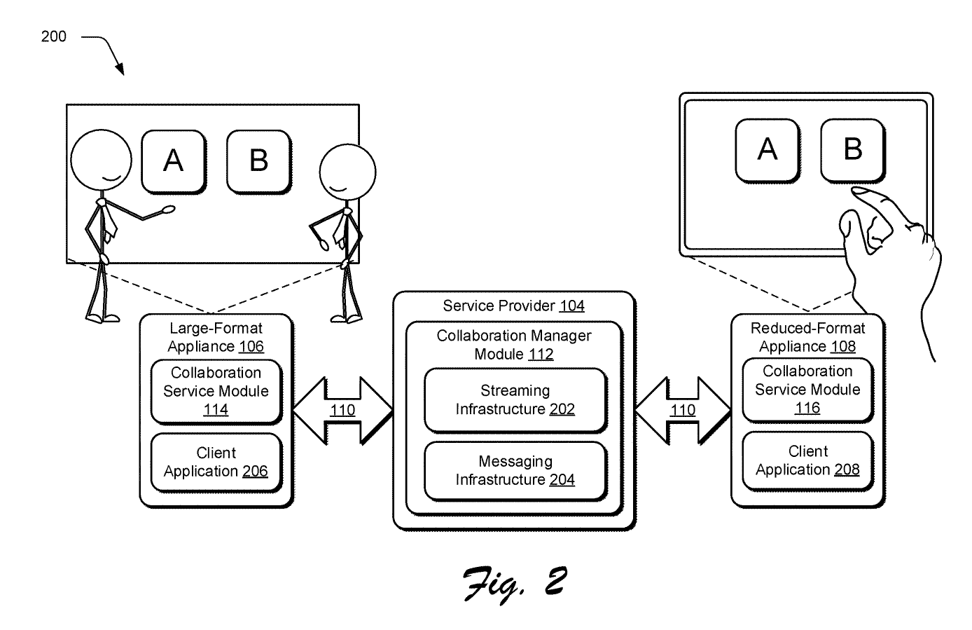

The service provider 104 is illustrated as including a collaboration manager module 112 and the appliances are illustrated as including respective collaboration service modules 114, 116 that together are representative of functionality implemented at least partially in hardware to support a shared workspace of a collaborative environment as further described in the following. Collaboration service modules 114, 116, for instance, may be configured as software such as applications, third-party plug-in modules, webpages, web applications, web platforms, and so on that support participation as part of a shared workspace. The collaboration manager module 112 is representative of functionality (e.g., implemented via software) that is usable to manage this interaction, examples of which are further described in relation to FIGS. 2-4. Although illustrated separately, functionality of the collaboration manager module 112 to manage the shared workspace may also be incorporated by the appliances themselves.

The collaboration service modules 114, 116, for instance, may be implemented as part of a web platform that work works in connection with network content, e.g. public content available via the “web,” to implement a shared workspace. A web platform can include and make use of many different types of technologies such as, by way of example and not limitation, URLs, HTTP, REST, HTML, CSS, JavaScript, DOM, and the like. The web platform can also work with a variety of data formats such as XML, JSON, and the like. Web platform can include various web browsers, web applications (i.e. “web apps”), and the like. When executed, the web platform allows a respective appliance to retrieve assets (e.g., web content) such as electronic documents in the form of webpages (or other forms of electronic documents, such as a document file, XML file, PDF file, XLS file, etc.) from a Web server (e.g., the service provider) for display on a display device in conjunction with the shared workspace.

The shared workspace is configured to share asset and user interactions with those assets. In the context of this disclosure, an “asset” may refer to any interactive renderable content that can be displayed on a display, such as on a display device of the large-format appliance 106 or reduced-format appliance 108, among others. Interactive renderable content is generally derived from one or more persistent or non-persistent content streams that include sequential frames of video data, corresponding audio data, metadata, flowable/reflowable unstructured content, and potentially other types of data.

Generally, an asset may be displayed within a dynamically adjustable presentation window. An example of this is illustrated presentation windows 118, 120 for the large-format appliance 106 and presentation window 122 as displayed for the reduced-format appliance 108. For simplicity, an asset and corresponding dynamically adjustable presentation window are generally referred to herein as a single entity, i.e., an “asset.” Assets may comprise content sources that are file-based, web-based, or Live Source. Assets may include images, videos, webpages (e.g., viewable within a browser, web-enabled application, web platform), documents, renderings of laptop screens, presentation slides, any other graphical user interface (GUI) of a software application, and the like.

An asset generally includes at least one display output generated by a software application, such as a GUI of the software application. In one example, the display output is a portion of a content stream. In addition, an asset is generally configured to receive one or more software application inputs. The reduced-format appliance 108, for instance, may include a display surface 124 (e.g., implemented by one or more display devices) having gesture detection functionality (e.g., a touch sensitive display device, a display device associated with one or more cameras configured to capture a natural user input, and so forth) to capture a gesture, such as an annotation 126 to circle text in a document made by one or more fingers of a user's hand 128. The annotation is then communicated and displayed on the large-format applicant 106 as annotation 126′ that also circles corresponding text in a presentation window 118 that is viewable by users 130, 132 of that appliance. Thus, unlike a fixed image, an asset is a dynamic element that enables interaction with the software application associated with the asset, for example, for manipulation of the asset. For example, an asset may include select buttons, pull-down menus, control sliders, and so forth that are associated with the software application and can provide inputs to the software application.

As also referred to herein, a “shared workspace” is a virtual digital canvas on which assets associated therewith, and their corresponding content streams, are displayed within a suitable dynamic “viewport window”. Thus, a shared workspace may comprise one or more associated assets (each asset displayed within a presentation window), whereby the entire shared workspace is displayed within a dynamically adjustable viewport window. A shared workspace may be displayed in the entire potential render area/space of a display device of the large-format appliance 106 and/or the reduced-format appliance 108, so that only a single shared workspace can be displayed on the surface thereof. In this case, the area of the viewport window that displays the shared workspace comprises the entire render area of the large-format appliance 106 and/or the reduced-format appliance 108. In other implementations, however, the shared workspace and the viewport window may be displayed in a sub-area of the total display area of the large-format appliance 106 and/or the reduced-format appliance 108 that does not comprise the entire render area of respective display devices of these appliances. For example, multiple shared workspaces may be displayed in multiple viewport windows on the large-format appliance 106 and/or the reduced-format appliance 108 concurrently, whereby each shared workspace and viewport window does not correspond to the entire display surface. Thus, workspace dimensions can be independent of the large format and reduced format display dimension. Each asset associated with a shared workspace, and content stream(s) corresponding to the asset, are displayed in a presentation window according to defined dimensions (height and width) and a location within the shared workspace and viewport window. The asset and presentation window dimensions and location may also be user-adjustable. As also referred to herein, a “project” may comprise a set of one or more related shared workspaces.

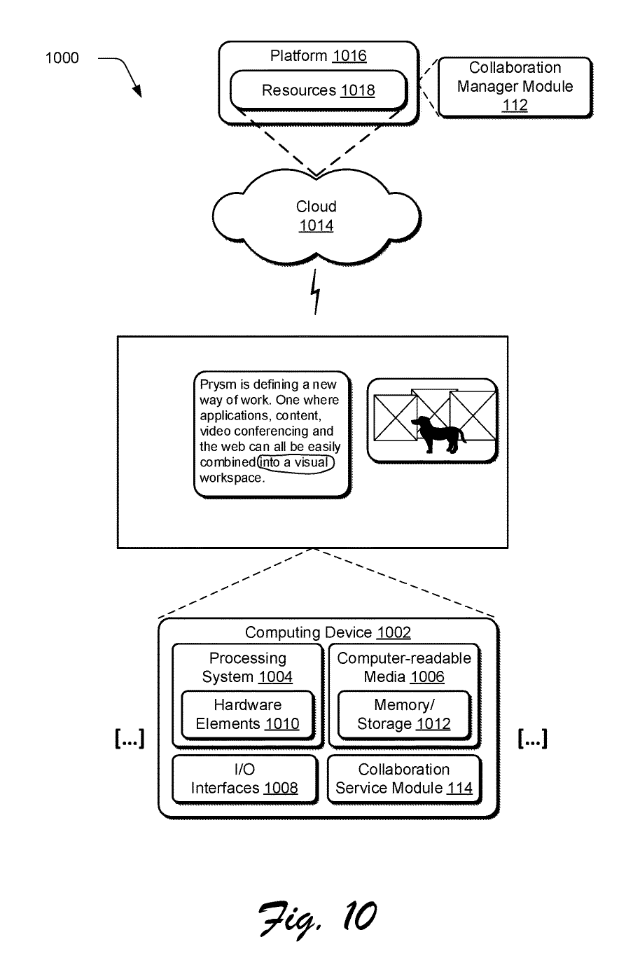

The large-format appliance 106 in this example is formed using a plurality of display tiles 134, e.g., arranged to form a display wall. The service provider 104 includes digital image content 136, which is illustrated as stored in collaboration data storage 136, e.g., using one or more memory devices as further described in relation to FIG. 10. The service provider 104 may receive this digital image content 136 from a variety of sources, such as the reduced-format appliance 108, the large-format appliance 106, remotely via a third-party source via the network 110 (e.g., a website), or from an information network or other data routing device, and converts said input into image data signals. Thus, digital image content 136 may be generated locally, with the large-format appliance 106 or the reduced-format appliance 108, or from some other location. For example, when the collaboration system 100 is used for remote conferencing, digital image content 136 may be received via any technically feasible communications or information network, wired or wireless, that allows data exchange, such as a wide area network (WAN), a local area network (LAN), a wireless (Wi-Fi) network, and/or the Internet, among others as represented by network 110. The service provider 104, reduced-format appliance 108, and large-format appliance 106 may be implemented as one of more computing devices, such as part of dedicated computers, as one or more servers of a server farm (e.g., for the service provider 104 as implementing one or more web services), dedicated integrated circuit, and so on. These computing devices are configured to maintain instructions in computer-readable media and that are executable by a processing system to perform one or more operations as further described in relation to FIG. 10.

Display devices of the large-format appliance 106 and/or the reduced-format appliance 108 may include the display surface or surfaces of any technically feasible display device or system type, including but not limited to the display surface of a light-emitting diode (LED) display, a digital light (DLP) or other projection displays, a liquid crystal display (LCD), optical light emitting diode display (OLED), laser-phosphor display (LPD) and/or a stereo 3D display all arranged as a single stand-alone display, head mounted display or as a single or multi-screen tiled array of displays. Display sizes may range from smaller handheld or head mounted display devices to full wall displays. In the example illustrated in FIG. 1, the large-format appliance 106 includes a plurality of display light engine and screen tiles mounted in an array, which are represented by the display tiles 134.

In operation, the large-format appliance 106 displays image data signals received from the service provider 104. For a tiled display, image data signals 102 are appropriately distributed among display tiles 134 such that a coherent image is displayed on a display surface 138 of the large-format appliance 106. Display surface 140 typically includes the combined display surfaces of display tiles 134. In addition, the display surface 138 of large-format appliance 106 is touch-sensitive that extends across part or all surface area of display tiles 134. In one implementation, the display surface 140 senses touch by detecting interference between a user and one or more beams of light, including, e.g., infrared laser beams. In other implementations, display surface 140 may rely on capacitive touch techniques, including surface capacitance, projected capacitance, or mutual capacitance, as well as optical techniques (e.g., sensor in a pixel), acoustic wave-based touch detection, resistive touch approaches, and so forth, without limitation and thus may detect “touch” inputs that do not involve actual physical contact, e.g., as part of a natural user interface. Touch sensitivity of the display surface 138 enables users to interact with assets displayed on the wall implementing touch gestures including tapping, dragging, swiping, and pinching. These touch gestures may replace or supplement the use of typical peripheral I/O devices, although the display surface 140 may receive inputs from such devices, as well. In this regard, the large-format appliance 106 may also include typical peripheral I/O devices (not shown), such as an external keyboard or mouse.

The display surface 140 may be a “multi-touch” surface, which can recognize more than one point of contact on the large-format appliance 106, enabling the recognition of complex gestures, such as two or three-finger swipes, pinch gestures, and rotation gestures as well as multiuser two, four, six etc. hands touch or gestures. Thus, a plurality of users 130, 132 may interact with assets on the display surface 140 implementing touch gestures such as dragging to reposition assets on the screen, tapping assets to display menu options, swiping to page through assets, or implementing pinch gestures to resize assets. Multiple users 130, 132 may also interact with assets on the screen simultaneously. Again, examples of assets include application environments, images, videos, webpages, documents, mirroring or renderings of laptop screens, presentation slides, content streams, and so forth. Touch signals are sent from the display surface 140 to the service provider 104 for processing and interpretation. It will be appreciated that the system shown herein is illustrative only and that variations and modifications are possible.

FIG. 2 is a conceptual diagram of a communication infrastructure 200 of the collaboration system 100 of FIG. 1 as sharing content streams across appliances, e.g., across the large and reduced format appliances 106, 108 through interaction with the service provider 104. As shown, this communication infrastructure 200 includes, without limitation, the large-format appliance 106 and the reduced-format appliance 108 communicatively coupled to service provider 104 via a network 110. As shown in FIG. 2, communication infrastructure 200 of this example implementation includes streaming infrastructure 202 and messaging infrastructure 204 included as part of the collaboration manager module 112 to support communication of the collaboration service modules 114, 116 to implement the shared workspace.

Large-format appliance 106 is illustrated as sharing a content stream A, via communication infrastructure 200, with the reduced-format appliance 108. In response, reduced-format appliance 108 is configured to retrieve content stream A from communication infrastructure 200 and to display that content stream on a display device of the reduced-format appliance 108 with its content stream B. Likewise, reduced-format appliance 108 is configured to share content stream B, via communication infrastructure 200, with the large-format appliance 106. In response, the large-format appliance 106 is configured to retrieve content stream B from communication infrastructure 200 and to display that content stream on a display device of the large-format appliance 106 with its content stream A.

In this fashion, the large and reduced format appliances 106, 108 are configured to coordinate with one another via the service provider 104 to generate a shared workspace that includes content streams A and B. Content streams A and B may be used to generate different assets rendered within the shared workspace. In one embodiment, each of the large and reduced format appliances 106, 108 perform a similar process to reconstruct the shared workspace, thereby generating a local version of that shared workspace that is similar to other local versions of the shared workspace reconstructed at other appliances. As a general matter, the functionality of the large and reduced format appliances 106, 108 are coordinated by respective collaboration service modules 114, 116 and client applications 206, 208, respectively.

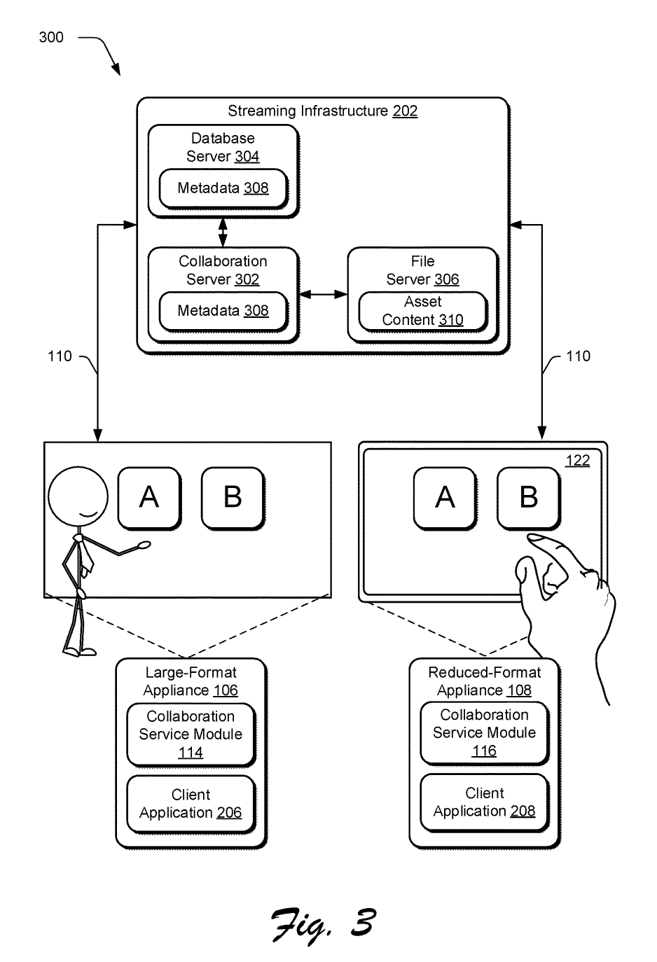

Client applications 206, 208 are software programs that generally reside within a memory (as further described in relation to FIG. 10) associated with the respective appliances. Client applications 206, 208 may be executed by a processing system included within the respective appliances. When executed, client applications 206, 208 setup and manage the shared workspace discussed above in conjunction with FIG. 2, which, again, includes content streams A and B. In one implementation, the shared workspace is defined by metadata that is accessible by both the large and reduced format appliances 106, 108. Each of the large and reduced format appliances 106, 108 may generate a local version of the shared workspace that is substantially synchronized with the other local version, based on that metadata (discussed below in relation to FIG. 3).

In doing so, client application 206 is configured to transmit content stream A to streaming infrastructure 200 for subsequent streaming to the reduced-format appliance 108. Client application 206 also transmits a message to the reduced-format appliance 108, via messaging infrastructure 204, that indicates to the large-format appliance 106 that content stream A is available and can be accessed at a location reflected in the message. In like fashion, client application 208 is configured to transmit content stream B to streaming infrastructure 202 for subsequent streaming to the large-format appliance 106. Client application 208 also transmits a message to the large-format appliance 106, via messaging infrastructure 204, that indicates to the large-format appliance 106 that content stream B is available and can be accessed at a location reflected in the message. The message indicates that access may occur from a location within streaming infrastructure 202.

Client application 206 may also broadcast a message via messaging infrastructure 204 to the reduced-format appliance 108 that specifies various attributes associated with content stream A that may be used to display content stream A. The attributes may include a location/position, a picture size, an aspect ratio, or a resolution with which to display content stream A on the reduced-format appliance 108, among others, and may be included within metadata described below in relation to FIG. 3. Client application 208 may extract the attributes from messaging infrastructure 204, and then display content stream A at a particular position on a display device of the reduced-format appliance 108, with a specific picture size, aspect ratio, and resolution, as provided by messaging infrastructure 204. Through this technique, the large-format appliance 106 is capable of sharing content stream A with the reduced-format appliance 108. The reduced-format appliance 108 is also configured to perform a complimentary technique in order to share content stream B with the large-format appliance 106.

Client applications 206, 208 are thus configured to perform similar techniques in order to share content streams A and B, respectively with one another. When client application 206 renders content stream A on a display device of the large-format appliance 106 and, also, streams content stream B from streaming infrastructure 202, the large-format appliance 106 thus constructs a version of a shared workspace that includes content stream A and B. Similarly, when client application 208 renders content stream B on a display device of the reduced-format appliance 108 and, also streams content stream A from streaming infrastructure 202, the large-format appliance 106 similarly constructs a version of that shared workspace that includes content streams A and B.

The appliances (e.g., the large and reduced format appliances 106, 108) discussed herein are generally coupled together via streaming infrastructure 202 and messaging infrastructure 204. Each of these different infrastructures may include hardware that is cloud-based and/or co-located on-premises with the various appliance, which are both represented by network 110. However, persons skilled in the art will recognize that a wide variety of different approaches may be implemented to stream content streams and transport messages/messages between display systems.

FIG. 3 depicts a block diagram 300 showing the streaming infrastructure 202 of FIG. 2 in greater detail. Streaming infrastructure 202 in this example includes a collaboration server 302, a database server 304, and a file server 306. Each server may comprise a computer device having a processor (such as processing system unit described in relation to FIG. 10) and a computer-readable medium such as memory, the processor executing software for performing functions and operations described herein. Collaboration server 302, database server 304, and file server 306 may be implemented as shown as separate and distinct computing devices/structures coupled to each other and to the appliances via a network 110. Alternatively, functionality of collaboration server 302, database server 304, and file server 306 may be implemented as a single computing device/structure in a single location (e.g., logically or virtually), or in any other technically feasible combination of structures. Further, one or more of collaboration server 302, database server 304, and/or file server 306 may be implemented as a distributed computing system. The network 110 may be via any technically feasible communications or information network, wired or wireless, that allows data exchange, such as a wide area network (WAN), a local area network (LAN), a wireless (WiFi) network, and/or the Internet, among others.

Collaboration server 302 coordinates the flow of information between the various appliances (e.g., the large and reduced format appliances 106, 108), database server 304, and file server 306. Thus, in some implementations, collaboration server 302 is a streaming server for the appliances. In some embodiments, the application program interface (API) endpoint for the appliances and/or business logic associated with streaming infrastructure 202 resides in collaboration server 302. In addition, collaboration server 302 receives requests from appliances and can send notifications to the appliances. Therefore, there is generally a two-way connection between collaboration server 302 and each of appliances, e.g., the large and reduced format appliances 106, 108. Alternatively or additionally, appliances may make requests on collaboration server 302 through the API. For example, during collaborative work on a particular project via collaboration system 100, an appliance may send a request to collaboration server 302 for information associated with an asset to display the asset in a shared workspace of the particular project.

Database server 304 (as well as collaboration server 302) may store metadata 308 associated with collaboration system 200, such as metadata for specific assets, shared workspaces, and/or projects. For example, such metadata may include which assets are associated with a particular shared workspace, which shared workspaces are associated with a particular project, the state of various settings for each shared workspace, annotations made to specific assets, etc. Metadata 308 may also include aspect ratio metadata and asset metadata for each asset. In some implementations, aspect ratio metadata may include an aspect ratio assigned to the project (referred to herein as the “assigned aspect ratio”). An aspect ratio assigned to a project applies to the shared workspaces of the project so that all shared workspaces of the project have the same aspect ratio assigned to the project. Asset metadata for an asset may specify a location/position and dimensions/size of the asset within an associated shared workspace.

The asset metadata indicates the position and size of an asset, for example, implementing horizontal and vertical (x and y) coordinate values. In some embodiments, the asset metadata may express the position and size of an asset in percentage values. In such implementations, the size (width and height) and position (x, y) of the asset is represented in terms of percent locations along an x-axis (horizontal axis) and y-axis (vertical axis) of the associated shared workspace. For example, the position and size of an asset may be expressed as percentages of the shared workspace width and shared workspace height. The horizontal and vertical (x and y) coordinate values may correspond to a predetermined point on the asset, such as the position of the upper left corner of the asset. Thus, when display surfaces of appliances have different sizes and/or aspect ratios, each asset can still be positioned and sized proportional to the specific shared workspace in which is it being displayed. When multiple display devices of multiple appliances separately display a shared workspace, each may configure the local version of the shared workspace based on the received metadata.

File server 306 is the physical storage location for some or all asset content 310 that are rendered as files, such as documents, images, and videos. In some embodiments, file server 306 can receive requests for asset content 310 directly from appliances. For example, an asset, such as a word-processing document, may be associated with a shared workspace that is displayed on a display device of a plurality of appliances, e.g., the large and reduced format appliances 106, 108. When the asset is modified by a user at the large-format appliance 106, metadata for a file associated with the asset is updated in file server 306 by collaboration server 302, the reduced-format appliance 108 downloads the updated metadata for the file from file server 306, and the asset is then displayed, as updated, on the display surface 124 of the reduced-format appliance 108. Thus, file copies of all assets for a particular shared workspace and project may be stored at the file server 306, as well as stored at each appliance that is collaborating on a project.

Each of appliances is an instance of a collaborative multi-media platform disposed at a different location in a collaboration system 100. Each collaboration appliance is configured to provide a digital system that can be mirrored at one or more additional and remotely located appliances. Thus, collaboration clients facilitate the collaborative modification of assets, shared workspaces, and/or complete presentations or other projects, as well as the presentation thereof.

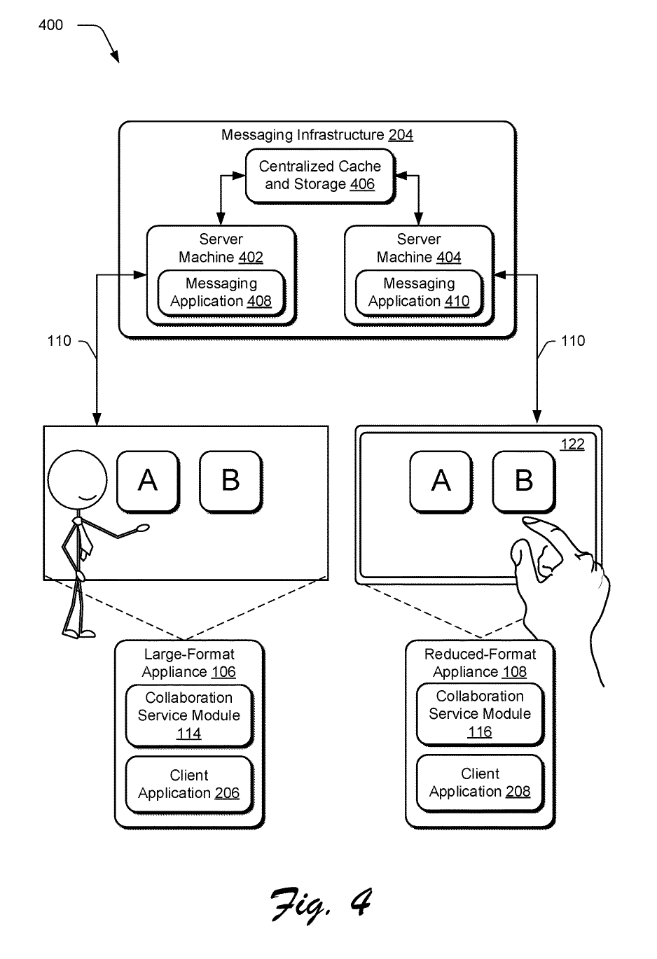

FIG. 4 depicts the messaging infrastructure 204 of FIG. 2 in greater detail. As shown, messaging infrastructure 204 includes server machines 402 and 404 coupled together via centralized cache and storage 406. Server machine 402 is coupled to the large-format appliance 106 and includes a messaging application 408. Server machine 404 is coupled to the reduced-format appliance 108 and includes a messaging application 410.

Server machines 402 and 404 are generally cloud-based or on-premises computing devices that include memory and processing systems as further described in relation to FIG. 10 configured to store and execute messaging applications 408 and 410, respectively. Messaging applications 408 and 410 are configured to generate real-time socket connections with the large and reduced format appliances 106, 108, respectively, to allow messages to be transported quickly between the appliances. In one implementation, messaging applications 408 and 410 are implemented as ASP.NET applications and rely on signalR WebSockets to accomplish fast, real-time messaging.

Centralized cache and storage 406 provides a persistent messaging back-end through which messages can be exchanged between messaging applications 408 and 410. In one embodiment, centralized cache and storage includes a Redis cache backed by a SQL database. Messaging applications 408 and 410 may be configured to periodically poll centralized cache and storage 406 for new messages, thereby allowing messages to be delivered to those applications quickly.

In operation, when the large-format appliance 106 transmits a message indicating that content stream A is available on streaming infrastructure 202, as described above, the large-format appliance 106 transmits that message to messaging application 408. Messaging application 408 may then relay the message to centralized cache and storage 406. Messaging application 410 polls centralized cache and storage 406 periodically, and may thus determine that that the message has arrived. Messaging application 410 then relays the message to the reduced-format appliance 108. The reduced-format appliance 108 may then parse the message to retrieve an identifier associated with the large-format appliance 106, and then stream content associated with the large-format appliance 106 from streaming infrastructure 202.

Having considered the above described collaborative workspace and supporting infrastructure, consider now a browser based snap grid in accordance with one or more embodiments.

Browser Based Snap Grid

Before describing various aspects of a snap grid, consider the environment in which snap grids can operate.

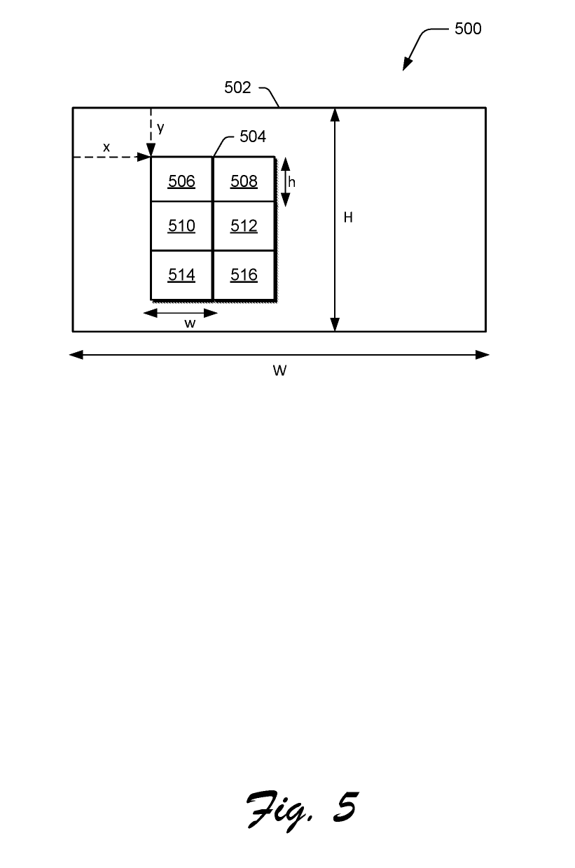

FIG. 5 illustrates an environment 500 that includes a large-format appliance having a display surface 502. Recall from the discussion above that a “shared workspace” is a virtual digital canvas on which assets associated therewith, and their corresponding content streams, are displayed within a suitable dynamic “viewport window”. This workspace may be shared with one or more users and/or locations. Thus, a shared workspace may comprise one or more associated assets (each asset displayed within a presentation window), whereby the entire shared workspace is displayed within a dynamically adjustable viewport window. A shared workspace may be displayed in the entire potential render area/space of a display device having display surface 502 of the large-format appliance, as in this example. This means that only a single shared workspace is displayed on the display surface. In this case, the area of the viewport window that displays the shared workspace comprises the entire render area of the large-format appliance and/or the reduced-format appliance. In other implementations, however, the shared workspace and the viewport window may be displayed in a sub-area of the total display area of the large-format appliance and/or the reduced-format appliance that does not comprise the entire render area of respective display devices of these appliances. In this case there would be a collection of workspaces. For example, multiple shared workspaces may be displayed in multiple viewport windows on the large-format appliance and/or the reduced-format appliance concurrently, whereby each shared workspace and viewport window does not correspond to the entire display surface. Each asset associated with a shared workspace, and content stream(s) corresponding to the asset, are displayed in a presentation window according to defined dimensions (height and width) and a location within the shared workspace and presented in a viewport window. The asset and presentation window dimensions and location may also be user-adjustable. As also referred to herein, a “project” may comprise a set of one or more related shared workspaces. In various embodiments, dimensions of the shared workspace are independent of dimensions of displays of the large-format and reduced-format applicances.

In the illustrated example, a snap grid 504 is shown. A snap grid is a logical object that defines a series of cells, such as cells 506, 508, 510, 512, 514, and 516. In this particular example, the cells have a rectangular shape, although any suitable shape can be utilized. Additionally, the illustrated cells are shown to be generally contiguous with one another. It is to be appreciated and understood, however, that the cells can be detached from one another and can be arranged in a fairly random or custom location or orientation or shape. That is to say, the cells do not necessarily need to define a specific tabular-style grid.

In operation, a snap grid (or snap arrangement) is assigned to a given workspace and serves to enable assets to be fixed in predefined locations within the workspace. A snap grid can have any number of cells that can be positioned anywhere within a particular workspace. Snap grids are defined and rendered based on percentages of the total workspace that the snap grid occupies. These percentages can be described by metadata to permit snap grids to be shared and rendered across other appliances in the collaborative environment.

In this manner, metadata describing these percentages can be shared with other appliances, such as reduced-format appliances, and based on this metadata, corresponding snap grids can be rendered in corresponding locations on the workspace of the other appliances. In some instances, snap grids can be rendered by a client application within a web browser. If a web browser is resized, associated web browser events cause the snap grids to be automatically recalculated using the same percentage-based formula that was used to originally render the snap grid on the web browser. This will typically be the case if the web browser's vertical viewport size is changed. This will cause the width dimension to be recalculated. If only the horizontal viewport size is changed, this will cause more of the workspace to be extended off to the right and add more “panning” area as described in this document. This recalculation can be performed anytime a user moves or resizes the web browser. So, for example, each individual cell of a snap grid can be defined by percentages of the total workspace that it occupies. As an example, consider cell 506.

Cell 506 has a top left corner that has an x position and a y position that collectively define an offset relative to the top left corner of the workspace. Note that the top left corner of the workspace is different from the top left corner of the display surface. This is because the workspace may logically extend outside of the display surface and may be pannable by a user to display content within unseen portions of the workspace. The x and the y positions for the top left corner of cell 506 can be expressed as a percentage of the overall width W and height H respectively, of the workspace. In this particular example, the workspace happens to be coextensive with the display surface. However, as pointed out above, this need not necessarily be the case.

Cell 506 also has a width w and a height h. The width w and the height h can also be expressed as a percentage of the overall width W and height H of the corresponding workspace. So, in this example, the following percentages may represent the percentages associated with cell 506:

Cell 506

| | |
|---|---|
| x location | 0.30 |
| y location | 0.25 |
| Width (w) | 0.30 |
| Height (h) | 0.25 |

Each cell of the snap grid can be represented in a similar way. During the course of the collaboration, snap grids and their corresponding content (assets) can be shared amongst other collaborating appliances. To do so, metadata describing these percentages can be formatted and shared out to the other collaborating appliances.

When the other collaborating appliances receive the formatted metadata, the collaborating appliances, through the use of their corresponding browsers, can render the snap grids in the same location relative to their own corresponding workspace. For example, assume that a reduced-format appliance receives the metadata associated with cell 506. The reduced-format appliance has its own workspace in which digital assets can be placed. The workspace of the reduced-format appliance has its own dimensions such as height and width. By using the computed percentages associated with cell 506, the reduced-format appliance and, more accurately, the appliance's browser, can compute the location of cell 506 as follows. In a very simple implementation, the x and y locations can be computed by multiplying the associated percentages by the width and height, respectively, of the workspace associated with the reduced-format appliance. Likewise, the width and height of cell 506 can be computed by multiplying the associated percentages by the width and height, respectively, of the reduced-format appliance. However, due to variations in appliance form factors, including display surfaces, other considerations can be taken into account to ensure that cells and their corresponding assets are scaled accurately when snap grids are shared amongst collaborators. This is described in more detail in the implementation example just below.

To place content into a snap grid cell, in at least some embodiments, a user can drag and drop an asset into the cell. In some instances tolerance thresholds can be set and used to ensure that an asset that is snapped into a snap grid cell automatically resizes to fit within the cell region without skewing the asset. That is, the asset is sized to fit but not necessarily fill the cell region. The tolerances define the minimum size difference and maximum size difference required to trigger the “snapping” behavior. Practically, this feature can be used so that users can define how “sensitive” they want the snap grid to be. So, for instance, a snap grid could be very sensitive to snap assets (i.e. content that is to be placed into a snap grid cell) whose center point is within its bounds, and whose size is almost anything less-than-or-equal to the grid cell, but any assets larger than the cell would not snap. Alternately, the snap grid could be configured so that assets that have X-Y dimensions such that the area is within 25% larger than the cell size, when rendered on the workspace, also snap when their midpoints are within the bounds of the cell. These overages and underages are configurable when the snap grid is created. Thus, not all content is necessarily automatically sized to fit a particular cell region. For instance, an asset that is very small when rendered (such as a very small thumbnail image), as perhaps determined by the user and the user's presentation content, may not necessarily be a good candidate to trigger the snap grid. That is, the user may wish for assets that the user determines to be small, to not exhibit a snap behavior because, for presentation purposes, it may be more desirable to present the asset at normal size so that multiple assets are visible. Any suitable tolerances can be utilized. For example, threshold tolerances may be set with respect to the size of a grid cell. So for example, a low tolerance threshold may be 80 percent of the size of the grid cell and a high tolerance threshold may be 120 percent the size of the grid cell. If an asset falls within these thresholds, then when it is placed into the snap grid, it can be automatically sized to fit the particular cell region. Fitting within the cell region maintains an item's aspect ratio. This means that for some assets, there may be space to the right and left of the asset when it is placed in the cell. For other assets, this may result in regions of overlap to the left and right of the cell such that the overlap causes panning instrumentalities to be presented to enable to the user to pan to content that is not currently viewable, as described in this document. This can be important for items such as photos and videos in order to maintain aspect ratios so as to not distort or skew the item. Other items such as whiteboards and the like can be expanded to fill the cell regions as these items do not physically have an intrinsic aspect ratio and will not be skewed by resizing to fill the cell region. In operation, when a user moves a particular asset into the boundary of a snap grid, as measured by the center point of the asset, the outline of the grid cell can be highlighted to give the user a visual indication that they can snap the object into the snap grid. Then, when the user releases the asset inside the grid cell, the asset can be automatically resized to match the size and position of the grid cell.

In one or more other embodiments, grid cells can be configured to enable assets to be easily exchanged as between cells in a somewhat automatic fashion. That is, software code executing on the appliance can maintain a list that describes the association between assets and grid cells. Thus, the software code can track which assets are assigned to which grid cells. If an asset gets snapped into a cell that already includes an asset, the software checks to determine whether the incoming asset was previously in another snap grid cell. If the asset was previously in another snap grid cell, the asset in the current cell is automatically swapped into the cell from which the incoming asset came. The incoming asset is then snapped into the current cell. In at least some embodiments, when this happens, each asset can be automatically resized to the corresponding cell into which it is snapped. If the incoming asset was not previously in another snap grid cell, the incoming asset is simply overlaid over the asset that is already in the snap grid cell.

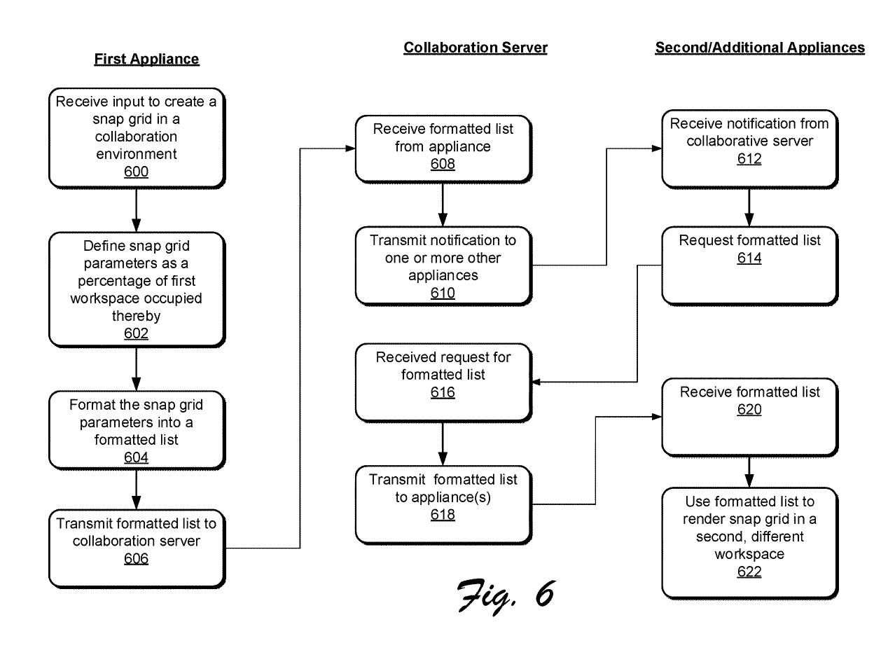

FIG. 6 depicts a procedure in an example implementation in which snap grids can be defined and shared in a shared workspace. In the illustrated example, the procedures are specified under three columns labeled “First Appliance”, “Collaboration Server”, and “Second/Additional Appliances” respectively. The column labels are intended to depict which entity performs which action. The first, second, and additional appliances can be any of the large-format appliance or the reduced-format appliance.

At block 600, the first appliance receives input to create a snap grid in a collaboration environment. Input can include, by way of example and not limitation, mouse input, stylus input, touch input, natural user interface input, gestural input, and the like. The snap grid can have any suitable dimension and any suitable number of cells. At block 602, snap grid parameters are defined as a percentage of a first workspace occupied by the snap grid. Examples of how this can be done are provided above and below. At block 604, the snap grid parameters are formatted into a formatted list. The formatted list can include any suitably-configured formatted list. In one embodiment, the formatted list is formatted in accordance with a JavaScript Object Notation (JSON) format, an example of which is described below. The formatted list can include various information including, by way of example and not limitation, locational coordinates of each cell of the snap grid as well as the percentage of the width and height, relative to the workspace, occupied by each cell of the snap. At block 606, the formatted list is transmitted to a collaboration server.

At block 608, the collaboration server receives the formatted list from the first appliance. At block 610, the collaboration server transmits a notification to one or more other appliances comprising part of the collaboration workspace. The notification can include a notification that a formatted list has been received and transmission can occur concurrently to all of the other appliances participating in the collaboration.

At block 612, a second and/or additional appliances receive the notification from the collaboration server and, at block 614, request the formatted list.

At block 616, the collaboration server receives the request for the formatted list and, at block 618, the collaboration server transmits the formatted list to the requesting appliance(s). In one or more embodiments, the list that is transmitted by the collaboration server can comprise the same list that the collaboration server received from the first appliance. Thus, in some embodiments, this list will be the JSON format list. The formatted list can be transmitted to multiple different appliances in a generally simultaneous manner. The goal of simultaneously transmitting the formatted list to multiple different appliances is to enable the snap grids to be configured to be rendered in a generally simultaneous manner across multiple reduced-format appliances. This provides a real time or near real time collaboration experience for the various participants. Of course, rendering times on the reduced-format appliances may vary so as to cause variations on when the individual snap grids are rendered. However, the intent is to provide snap grids that are configured to be rendered in a generally simultaneous manner across these multiple devices.

At block 620, the second and/or additional appliances receive the formatted list and, at block 622, the second and/or additional appliances use the formatted list to render the snap grid in a second, different workspace. In at least some embodiments, the second workspace can be associated with an appliance having a display surface with a different form factor than the display surface of the first appliance. In at least some embodiments, the snap grid is configured to be modified by the second additional appliances, which may include one or more reduced-format appliances. In some instances, the modified snap grid can then be shared with other applications, such as a large-format appliance. Sharing can take place using an approach that employs formulating a formatted list, such as that described above.

Having considered an overview of an example snap grid and an example method, consider now an implementation example in accordance with one or more embodiments.

Implementation Example

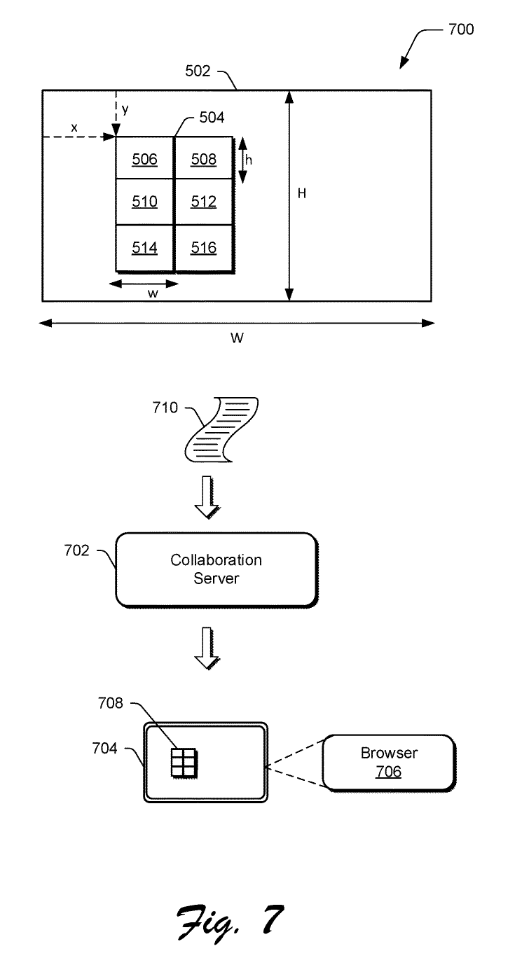

FIG. 7 illustrates a system in accordance with one or more embodiments generally at 700. System 700 includes the large-format appliance from FIG. 5 having the display surface 502. In this example, the snap grid 504 has been defined and rendered on the display surface 502. The system also includes a collaboration server 702 and a reduced-format appliance 704. In the illustrated and described embodiment, the reduced-format appliance 704 includes a web platform in the form of a browser 706 which is operable to render shared content, such as snap grid 708, on the reduced-format appliance. In this example, the snap grid 708 corresponds to the snap grid 504 that is rendered on the large-format appliance.

In the illustrated and described embodiment, browser 706 is WebGL-enabled. As will be appreciated by the skilled artisan, WebGL, which stands for “Web Graphics Library,” is a JavaScript API for rendering interactive 3-D computer graphics and 2-D graphics within any compatible web browser without the use of plug-ins. WebGL is integrated into all the web standards of the browser allowing GPU accelerated usage of physics and image processing and effects as part of the webpage canvas. WebGL elements can be mixed with other HTML elements and compounds and with other parts of the page or page background. WebGL programs include control code written in JavaScript and shader code that is executed on a computer's Graphics Processing Unit (GPU). Web browser 706 can also use Canvas APIs for rendering content. The Canvas APIs allow for dynamic, scriptable rendering of 2-D shapes and bitmap images. Other technologies for rendering content can be utilized without departing from the spirit and scope of the claimed subject matter.

In this example, when the snap grid is shared with other collaborating appliances, metadata describing the snap grid, such as a snap grid ID, x and y locations, width, height, and various other properties can be formatted into a list, such as list 710, and provided to the collaboration server 702.

In at least some embodiments, the formatted list of metadata is represented using a JavaScript Object Notation (JSON) format. JSON is an open standard format that uses human-readable text to transmit data objects consisting of attribute-value pairs. JSON is commonly used for asynchronous browser/server communication. Some example properties and attributes of the JSON format can include the following:

| Attribute | Definition |
|---|---|
| SnapGridId | Defines the unique ID of the snap grid. |
| Name | Defines the name of the snap grid. |
| SnapOnAdd | A Boolean true/false that determines whether assets |
| | should automatically snap into the grid cell when they |
| | are added to the stage. This only happens if nothing |
| | else is already snapped into the cell. |
| SnapOnMove | A Boolean true/false that determines if assets should |
| | be snapped into the cell when positioned within the |
| | cell. Usually used in conjunction with the above to |
| | enable/disable interactive snapping vs snapping when |
| | items are added. |
| ScaleMode | Used to determine whether assets intelligently fill the |
| | cell or always size to fill (stretching vs maintaining aspect ratio). |
| SnapGridTemplate | Refers to the entire snapgrid data (minus the settings). |
| | It has SnapGridTemplateGrid |
| | and SnapGridTemplateRectCollection. |
| | SnapGridTemplateGrid has global snapgrid positioning and size. |
| SnapGridTemplateGrid | SnapGridTemplateRectCollection has |
| | SnapGridTemplateRects which use |
| | SnapGridTemplateGrid size and position as 100 |
| | percent. so if SnapGridTemplateGrid is set to 50% |
| | width, a SnapGridTemplateGrid which has width of |
| | 100% will really only be 50%. Basically, a bounding |
| | box around which the other percentages are adjusted. |
| | (if the entire grid only takes up a portion of the virtual |
| | workspace, rather than the whole thing) |
| LeftPercent | The percentage of the virtual workspacestage from the |
| | left edge at which the snapgrid cell should be positioned. |
| TopPercent | Same as above but for positioning the asset's Y position. |
| WidthPercent | Same as above but for the width of the asset |
| HeightPercent | Same as above but for the height of the asset |
| AspectRatioId | The aspect ratio to which this snap grid belongs (in our |
| | database). Each Snap Grid is assigned to a given |
| | aspect ratio. |

In the illustrated and described embodiment, the JSON format list is communicated to the collaboration server via a REST (Representational State Transfer) API in an HTTPS call to the collaboration server 702 which causes the JSON format list to be posted to the server. When the collaboration server 702 receives the JSON format list, the collaboration server sends out a notification to the other appliances, by way of a persistent Web socket connection, that a new snap grid list has been received.

After the other appliances have received the notification from the collaboration server, the appliances can make a request to the collaboration server for the newly received list.

Each appliance's browser, such as browser 706, then processes the list and can use WebGL (or any other suitable technology) to render the snap grid on their own display device.

As noted above, the snap grid is rendered by way of the percentages described in the JSON format list relative to the workspace size of the appliance that received the JSON format list.

In at least some embodiments, when the user initiates a project, the user can define an aspect ratio (a ratio of width/height) that the project is to have. This can be done in any suitable way. For example, at least some embodiments, the aspect ratio can be defined by the user in XML, using a SnapGridTemplate (in the table above) that defines the overall grid structure. That is, the user can define the aspect ratio of the workspace within which snap grids and other assets appear. This aspect ratio can be included in the metadata that appears in the JSON format list. So, for example, the user may define an aspect ratio of 16:9 for a particular project. The aspect ratio essentially defines the shape of the workspace. When the snap grid and other assets that might be displayed on a large-format appliance are rendered on other appliances, the content is rendered in a manner which seeks to preserve the originally-defined aspect ratio, even though the appliance may have a different display size. Doing so ensures that assets, including those contained within a particular snap grid cell, are not visually skewed.

In one or more embodiments, to take into account the defined aspect ratio on a differently-dimensioned appliance, the snap grid vertical dimension and other assets are scaled to fit the vertical dimension of the appliance's display. In one or more embodiments, this occurs on the appliance at runtime. It is to be appreciated and understood, however, that scaling can occur at other locations, such as on the server. The horizontal dimension of the snap grid and other assets are then scaled based on the aspect ratio that was defined for the project. So, for example, if an aspect ratio of 16:9 is defined for the project, and a snap grid and other assets are shared with an appliance that has a narrower aspect ratio, the snap grid and other assets will be scaled to fit the vertical resolution of the appliance, and the horizontal resolution will be scaled to preserve the aspect ratio. In this instance, doing so will create overflow to the left and right of the physical display device. To address this, left and right panning instrumentalities can be provided to enable the user to pan the workspace to the left and right to see all of the content that resides on the workspace on their particular appliance.

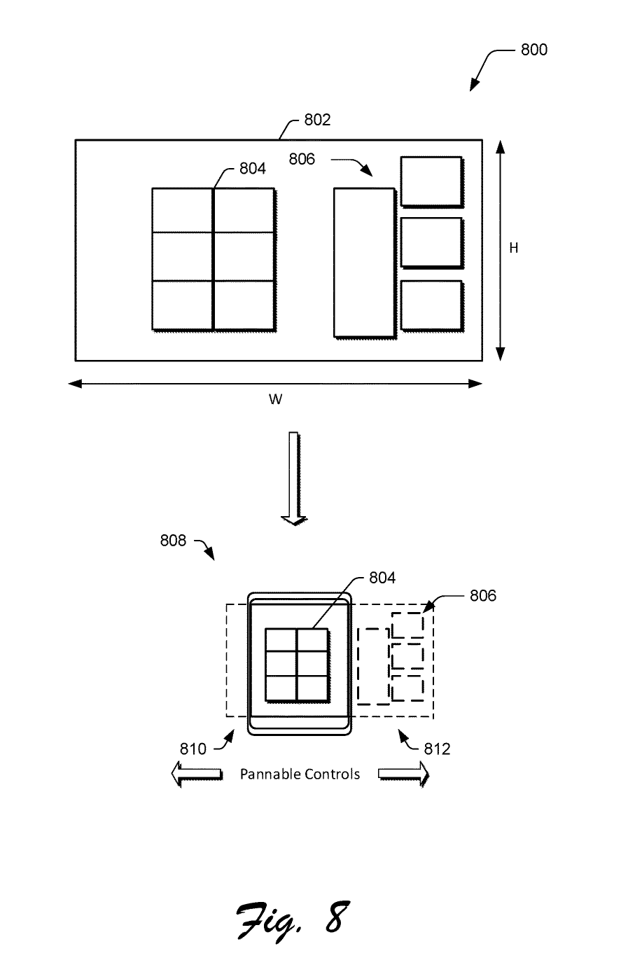

As a visual example, consider FIG. 8 which illustrates a system, generally at 800, that includes a large-format appliance having a display surface 802. In this particular example, the display surface is used to display content associated with a project having one workspace that has an aspect ratio of W/H. Within the workspace is included a snap grid 804 and a collection of assets 806. When the content of this project is shared with a reduced-format appliance 808 having a display surface with a different, in this case narrower, aspect ratio, all of the content from the workspace of the large-format appliance is rendered in the same location and at the same relative size and shape with respect to the reduced-format appliance. To do so, the vertical dimension of all the content within the workspace—that is, the snap grid and a collection of assets—is scaled to fit the vertical dimension of the display of the reduced-format appliance. In addition, to maintain the aspect ratio originally defined by the user for the project, and to ensure that none of the assets are stretched or skewed, the horizontal dimension of the content is scaled based on the originally-defined aspect ratio in order to preserve that aspect ratio.

For example, notice in the reduced-format appliance 808, that the snap grid 804 has been scaled to fit within the vertical dimension of the appliance. That is, the corresponding workspace from the large-format appliance has been scaled to fit within the vertical dimension of the reduced-format appliance. The horizontal dimension of the corresponding workspace has been scaled to maintain the original aspect ratio of W/H. In doing so, two regions of overlap 810, 812 (indicated by the dashed line) are defined. Region 812 includes the collection of assets 806 which are not currently viewable. In order to enable the user to view the collection of assets 806, pannable controls are rendered by the browser to pan from left to right. So, a user can pan to the right to view region 812. Doing so moves region 810 further to the left and moves snap grid 804 out of view.

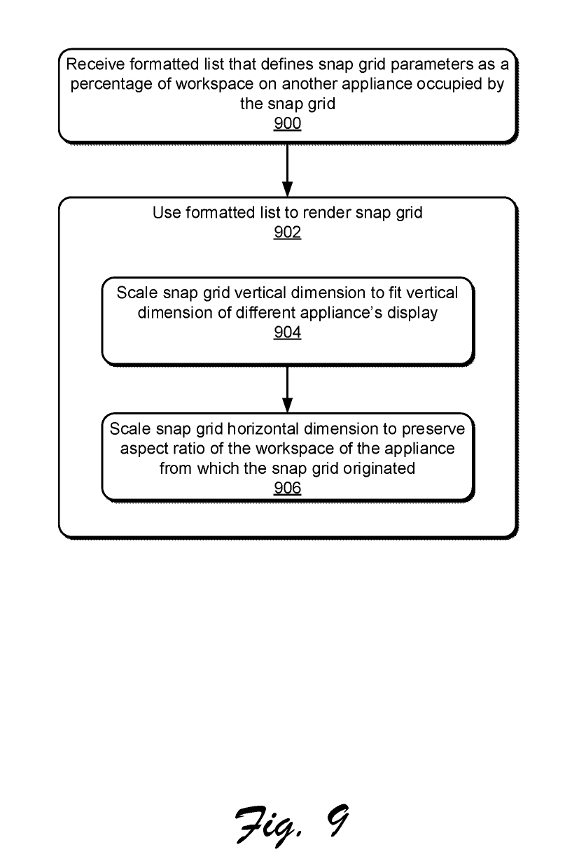

FIG. 9 depicts a procedure in an example implementation in which snap grids can be defined and shared in a shared workspace. The procedure can be performed by any suitably-configured appliance.

At block 900, a formatted list that defines snap grid parameters is received by an appliance. In the illustrated and described embodiments, the snap grid parameters are defined as a percentage of workspace on another appliance occupied by the snap grid. An example of how this can be done is provided above. At block 902, the formatted list is used by the receiving appliance to render the snap grid. This can be done by ascertaining, from the snap grid parameters, x and y coordinates of the snap grid. The snap grid can then be rendered then scaled, at block 904, in the vertical dimension to fit the vertical dimension of the receiving appliance's display. At block 608, the snap grid horizontal dimension can be scaled to preserve the aspect ratio of the workspace of the appliance from which the snap grid originated. In this manner, the content that is rendered, including snap grids and any other assets, will not be skewed or stretched. In some instances, such as those where the receiving appliance has a display with an aspect ratio that is larger than the aspect ratio of the device from which the snap grid was received, the newly-rendered snap grid and associated content will be contained entirely within the horizontal extent of the appliance's display. On the other hand, in instances where the receiving appliance has a display with an aspect ratio that is smaller than the aspect ratio of the device from which the snap grid was received, the newly-rendered snap grid and associated content will be rendered to include regions that extend outside the horizontal extent of the appliance's display. Such was the case in the example of FIG. 8.

Consider now some design considerations for moving and resizing a browser that is being utilized to display shared content in the collaborative environment.

Design Considerations for Moving and Resizing the Browser and Other Considerations

One property of a web browser is that the web browser's window, within which content is displayed, can be dynamically resized by a user. So, for example, in a reduced-format appliance, the user can dynamically resize the browser window which, in turn, can cause, if left unaddressed, visual modifications to content displayed by the browser.

In one or more embodiments, an event listener is added to the system and listens for browser events associated with a browser window move or resize action. When a window move or resize action occurs, the corresponding event is triggered and any snap grids and other assets are re-rendered using the techniques described above. For example, if a browser window is resized such as by reducing or expanding it, the formatted list containing the snap grid parameters, such as those described in connection with FIG. 6, can be used to render the snap grid in the newly-resized browser window. In at least some embodiments, this can be done by rendering outlines of the snap grid using WebGL or HTML5 Canvas.

It is to be appreciated and understood that while the examples above illustrate the notion of sharing assets and snap grids from a large-format appliance to a reduced-format appliance, the reverse can work equally as well. That is, assets and snap grids can be originated or modified on a reduced-format appliance and then shared from the reduced-format appliance to a large-format appliance (as well as shared to other differently dimensioned reduced-format appliances) using the principles described above.

Having considered the above-described embodiments, consider now an example system and device that can be utilized to implement the principles described above.

Example System and Device

FIG. 10 illustrates an example system generally at 1000 that includes an example computing device 1002 that is representative of one or more computing systems and/or devices that may implement the various techniques described herein. This is illustrated through inclusion of the collaboration service module 114 and collaboration manager module 112. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1006 is illustrated as including memory/storage 1012. The memory/storage 1012 represents memory/storage capacity associated with one or more computer-readable media. The memory/storage component 1012 may include volatile media (such as random access memory (RAM)) and/or nonvolatile media (such as read only memory (ROM), Flash memory, optical disks, magnetic disks, and so forth). The memory/storage component 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

The techniques described herein may be supported by various configurations of the computing device 1002 and are not limited to the specific examples of the techniques described herein. This functionality may also be implemented all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 may include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 may abstract resources and functions to connect the computing device 1002 with other computing devices. The platform 1016 may also serve to abstract scaling of resources to provide a corresponding level of scale to encountered demand for the resources 1018 that are implemented via the platform 1016. Accordingly, in an interconnected device embodiment, implementation of functionality described herein may be distributed throughout the system 1000. For example, the functionality may be implemented in part on the computing device 1002 as well as via the platform 816 that abstracts the functionality of the cloud 1014.

### CONCLUSION

Various embodiments provide a so-called snap grid that can be shared amongst various appliances in a collaborative workspace environment. A snap grid is a logical object that defines a series of cells. The cells can have any shape, but are typically four-sided in nature, such as rectangular. The cells can be generally contiguous with one another, or can be detached from one another and spread out across a workspace.

In operation, a snap grid is assigned to a given workspace and serves to enable assets, such as digital content, to be fixed in predefined locations within the workspace. In some instances, an asset can be placed into a grid cell and can be automatically re-sized to fit the cell. A snap grid can have any number of cells that can be positioned anywhere within a particular workspace. Snap grids are defined and rendered based on percentages of the total workspace that the snap grid occupies. These percentages can be described by metadata to permit snap grids to be shared and rendered across other appliances in the collaborative environment.

In this manner, metadata describing these percentages can be shared with other appliances, such as reduced-format appliances, and based on this metadata, corresponding snap grids can be rendered in corresponding locations on the workspace of the other appliances.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a first large-format appliance in a collaborative work environment that includes one or more other reduced-format appliances, input to create a snap grid having individual grid cells, the individual grid cells being configured to be located in predefined locations within a shared workspace as defined utilizing the first large-format appliance, individual grid cells being configured to receive an asset, the shared workspace being shared among the one or more other reduced-format appliances;
defining snap grid parameters as a percentage of the first appliance's defined workspace occupied by the snap grid;
formatting the snap grid parameters into a formatted list; and
causing the formatted list to be transmitted to the one or more other reduced-format appliances, wherein the formatted list is configured to enable a respective web platform executing on the one or more other reduced-format appliances to render corresponding snap grids in a same relative workspace location as the first appliance's shared workspace, wherein snap grids are configured to be rendered in a generally simultaneous manner across multiple reduced-format appliances.

2. A method as described in claim 1, wherein dimensions of the shared workspace are independent of dimensions of displays of the large-format and reduced-format appliances.

3. A method as described in claim 1, wherein individual grid cells are rectangular.

4. A method as described in claim 1, wherein individual grid cells are contiguous with each other.

5. A method as described in claim 1, wherein at least some individual grid cells are not contiguous with other individual grid cells.

6. A method as described in claim 1, wherein the formatted list is formatted in accordance with a JavaScript Object Notation (JSON) format.

7. A method as described in claim 1, wherein the snap grid parameters include locational coordinates of each grid cell and width and height percentages relative to a width and height of the first large-format appliance's defined workspace.

8. A method as described in claim 1, wherein the causing comprises transmitting the formatted list to a collaboration server configured to enable said one or more other reduced-format appliances to obtain the formatted list.

9. A method as described in claim 1, wherein the formatted list is configured to enable snap grids rendered on the one or more other reduced-format appliances to be recomputed if a corresponding web browser is resized.

10. One or more computer-readable storage media comprising instructions that are stored thereon that, responsive to execution by an appliance, causes the appliance to perform operations comprising:
receiving, from a large-format appliance in a collaborative work environment, a formatted list defining snap grid parameters for a snap grid, the snap grid parameters being defined as a percentage of a shared workspace as defined by the large-format appliance that is occupied by the snap grid, the snap grid having individual grid cells that are configured to be located in predefined locations within the shared workspace and to receive an asset, the shared workspace being shared with one or more reduced-format appliances; and
using the formatted list, by a web platform of a reduced-format appliance, to render a snap grid in a corresponding workspace of the reduced-format appliance in the collaborative work environment, the snap grid parameters being used to render the snap grid in the corresponding workspace in a same corresponding location as a location of the snap grid in the shared workspace defined by the large-format appliance.

11. One or more computer-readable storage media as described in claim, 10, wherein individual grid cells include four sides.

12. One or more computer-readable storage media as described in claim, 10, wherein individual grid cells are rectangular.

13. One or more computer-readable storage media as described in claim, 10, wherein individual grid cells are contiguous with each other.

14. One or more computer-readable storage media as described in claim, 10, wherein at least some individual grid cells are not contiguous with other individual grid cells.

15. One or more computer-readable storage media as described in claim, 10, wherein the snap grid is configured to be modified by the one or more reduced-format appliance and shared with the large-format appliance.

16. One or more computer-readable storage media as described in claim, 10, wherein the snap grid parameters include locational coordinates of each grid cell and width and height percentages relative to the width and height of the shared workspace of the large-format appliance.

17. One or more computer-readable storage media as described in claim 10, wherein the web platform comprises a web browser and further comprising using one or more web browser events to cause recalculation of the size of the snap grid in the corresponding workspace of the reduced-format appliance responsive to the web browser being moved or resized.

18. One or more computer-readable storage media as described in claim, 10, wherein using the formatted list comprises scaling the snap grid in the corresponding workspace of the reduced-format appliance to preserve an aspect ratio associated with the workspace of the large-format appliance.

19. A system comprising:
a display;
one or more processors;
one or more computer-readable storage media comprising instructions stored thereon which, responsive to execution by the one or more processors, cause a snap grid to be rendered on the display by performing operations comprising:
receiving, from a large-format appliance in a collaborative work environment, a formatted list defining snap grid parameters for the snap grid, the snap grid parameters being defined as a percentage of a shared workspace as defined by the large-format appliance that is occupied by the snap grid, the snap grid having individual grid cells that are configured to be located in predefined locations within the shared workspace and to receive an asset, the shared workspace being shared among one or more reduced-format appliances; and
using the formatted list, by a web platform of the system, to render a snap grid in a corresponding workspace on the display, the snap grid parameters being used to render the snap grid in the corresponding workspace in a same corresponding location as a location of the snap grid in the shared workspace defined by the large-format appliance.

20. The system of claim 19, wherein the snap grid parameters include locational coordinates of each grid cell and width and height percentages relative to the width and height of the shared workspace defined by the large-format appliance.
